(19) United States
(12) Patent Application Publication
(10) Pub. No.: US 2010/0307788 A1
(43) Pub. Date: Dec. 9, 2010

(54) SEMICONDUCTIVE PEELABLE CROSSLINKED RESIN COMPOSITION AND INSULATING CABLE MANUFACTURED USING THE SAME

(75) Inventors: Ung Kim, Gunpo-si (KR); Hwa-Joon Lim, Seongnam-si (JP); Yong-Sun Lee, Chilgok-gun (KR); Jin-Ho Nam, Guri-si (KR)

Correspondence Address: North Star Intellectual Property Law, PC, P.O. Box 34688, Washington, DC, 20043, US

(73) Assignee: LS CABLE LTD.

(21) Appl. No.: 12/867,074

(22) PCT Filed: Jun. 26, 2008
(86) PCT No.: PCT/KR08/03696

§ 371 Date: Aug. 11, 2010

(30) Foreign Application Priority Data
Feb. 12, 2008 (KR) 10-2008-0012594

(51) Int. Cl. H01B 9/02; H01B 1/24

(52) U.S. Cl. 174/107; 252/511

(57) ABSTRACT

The present invention relates to a peelable and water-crosslinked semiconductive resin composition. The peelable and water-crosslinked semiconductive resin composition includes 100 parts by weight of a basic resin; 20 to 80 parts by weight of carbon black based on weight of the basic resin; and 0.05 to 5.0 parts by weight of an amide-based lubricant based on weight of the basic resin, wherein the basic resin is a mixed resin including 60 to 80 weight % of an ethylene-based copolymer resin that is bonded with an unsaturated organic silane and has a melting point of 80° C. or above; 5 to 20 weight % of an ethylene-acrylic acid copolymer or its alkali metal salt; and 5 to 40 parts by weight of an ethylene propylene copolymer containing 5 to 20 weight % of ethylene, or a propylene rein.

### TECHNICAL FIELD

The present invention relates to a peelable and water-crosslinked semiconductive resin composition and an insulating cable using the same, and in particular, to a peelable and water-crosslinked semiconductive resin composition that is bonded with an unsaturated organic silane, includes carbon black and an amide-based lubricant, and has a predetermined melting point or above, consequently can be crosslinked at high temperature, and an insulating cable using the same.

### BACKGROUND ART

Generally, a resin composition, in which an unsaturated silane is bonded to a polyethylene or ethylene copolymer, is crosslinked to meet electrical and mechanical characteristics of resin. In the crosslinking, time is a function related to temperature, and as temperature of water increases, crosslinking time reduces. Thus, high temperature is a preferable crosslinking condition in aspect of production efficiency. Accordingly, if a cable is crosslinked, a resin composition for the cable should have a higher melting point than a crosslinking temperature so that the cable can be crosslinked at a predetermined temperature or below.

To reduce the water-crosslinking time, it requires to increase the temperature of a crosslinking chamber. Thus, a resin for a cable should have such a high melting point to avoid thermal deformation at high temperature.

According to the prior art disclosed in U.S. Pat. No. 6,284,374, in the case that a resin composition having a lower melting point than a crosslinking temperature is used, a wound cable may be stuck together or pressed down during crosslinking. In the case that an ethylene vinyl acetate copolymer resin is used, the content of acetate in the resin should be decreased to increase a melting point of the resin, but compatibility between a polyethylene insulator and an outer semiconductive composition increases, resulting in difficult separation therebetween.

### DISCLOSURE

### Technical Problem

Therefore, the present invention is designed to solve the above-mentioned problems. An object of the present invention is to provide a peelable and water-crosslinked semiconductive resin composition that has an increased melting point through composition control and can be crosslinked at high temperature to reduce the crosslinking time, and an insulating cable using the same.

### Technical Solution

In order to achieve the above-mentioned object, a peelable and water-crosslinked semiconductive resin composition according to the present invention includes 100 parts by weight of a basic resin; 20 to 80 parts by weight of carbon black based on weight of the basic resin; and 0.05 to 5.0 parts by weight of an amide-based lubricant based on weight of the basic resin, wherein the basic resin is a mixed resin including 60 to 80 weight % of an ethylene-based copolymer resin that is bonded with an unsaturated organic silane and has a melting point of 80° C. or above; 5 to 20 weight % of an ethylene-acrylic acid copolymer or its alkali metal salt; and 5 to 40 parts by weight of an ethylene propylene copolymer containing 5 to 20 weight % of ethylene, or a propylene rein.

Preferably, the ethylene-based copolymer resin of the basic resin is any one selected from the group consisting of an ethylene vinyl acetate copolymer resin, an ethylene ethyl acrylate copolymer resin, an ethylene methyl acrylate copolymer resin and an ethylene butyl acrylate copolymer resin.

Preferably, the ethylene vinyl acetate copolymer resin selected as the ethylene-based copolymer resin contains 9 to 25 weight % of vinyl acetate, the ethylene ethyl acrylate copolymer resin selected as the ethylene-based copolymer resin contains 9 to 35 weight % of ethyl acrylate, the ethylene methyl acrylate copolymer resin selected as the ethylene-based copolymer resin contains 9 to 35 weight % of methyl acrylate, and the ethylene butyl acrylate copolymer resin selected as the ethylene-based copolymer resin contains 9 to 35 weight % of butyl acrylate.

Preferably, the amide-based lubricant contains an amide function (—CON—) in a hydrocarbon main chain, is represented by the following Chemical FIG. 1, and has a melting point of 50° C. to 120° C.

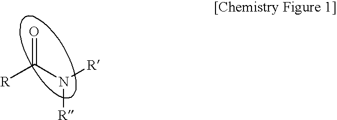

where R is a hydrocarbon main chain, and R′ and R″ each is hydrogen or a hydrocarbon chain.

Preferably, the amide-based lubricant is any one selected from the group consisting of stearamide, oleamide, erucamide, hydrogenated tallowamide, oleyl palmitamide and stearyl stearamide, or mixtures thereof.

In order to achieve the above-mentioned object, an insulating cable according to the present invention includes a center conductor; an inner semiconductive layer surrounding the center conductor; a water-crosslinked insulating layer surrounding the inner semiconductive layer; an outer semiconductive layer surrounding the water-crosslinked insulating layer; a copper tape surrounding the outer semiconductive layer; and a sheath layer surrounding the copper tape, wherein outer semiconductive layer is formed using the above-mentioned peelable and water-crosslinked semiconductive resin composition.

### DESCRIPTION OF DRAWINGS

Preferred embodiments of the present invention will be more fully described in the following detailed description, taken accompanying drawings. However, it should be understood that the description proposed herein is just a preferable example for the purpose of illustrations only, not intended to limit the scope of the invention.

FIG. 1 is a cross-sectional view of an insulating cable having an outer semiconductive layer formed using a composition according to the present invention.

### BEST MODE

Hereinafter, preferred embodiments of the present invention will be described in detail with reference to the accompanying drawings. The description proposed herein is just a preferable example for the purpose of illustrations only, not intended to limit the scope of the invention, so it should be understood that other equivalents and modifications could be made thereto without departing from the spirit and scope of the invention. The preferred embodiments of the present invention are provided to help persons having ordinary skills in the art understand the present invention more completely.

To evaluate the effectiveness of the present invention, as shown in the following Table 1, resin compositions were prepared according to examples 1 to 5 of the present invention and comparative examples 1 to 5, and polymer material samples and cable samples were manufactured using the compositions.

TABLE 1

| | Examples | | | | | Comparative examples | | | | |
|---|---|---|---|---|---|---|---|---|---|---|
| Classification | 1 | 2 | 3 | 4 | 5 | 1 | 2 | 3 | 4 | 5 |
| Resin a | 80 | 80 | 70 | 80 | | 100 | 20 | | 80 | 80 |
| Resin b | | | | | | | | 80 | | |
| Resin c | | | | | 80 | | | | | |
| Resin d | 10 | 10 | 15 | 10 | 10 | | 45 | 10 | 10 | 10 |
| Resin e | 10 | 10 | 15 | | 10 | | 35 | 10 | 10 | 10 |
| Resin f | | | | 10 | | | | | | |
| Lubricant | | 0.2 | 0.2 | 0.2 | 0.2 | | | | 0.2 | 0.2 |
| Carbon black | 60 | 60 | 60 | 60 | 60 | 60 | 60 | 60 | 10 | 100 |
| Additive | 3.5 | 3.5 | 3.5 | 3.5 | 3.5 | 3.5 | 3.5 | 3.5 | 3.5 | 3.5 |

In Table 1, the ‘resin a’ is an ethylene vinyl acetate copolymer resin that is bonded with an unsaturated organic silane, contains 19 weight % of vinyl acetate and has a melting point of 84° C., the ‘resin b’ is an ethylene vinyl acetate copolymer resin that is bonded with an unsaturated organic silane, contains 30 weight % of vinyl acetate and has a melting point of 72° C., the ‘resin c’ is an ethylene methyl acrylate copolymer resin that is bonded with an unsaturated organic silane, contains 30 weight % of methyl acrylate and has a melting point of 86° C., the ‘resin d’ is an ethylene propylene copolymer resin that contains 5 weight % of ethylene and has a melting point of 137° C., the ‘resin e’ is an ethylene acrylic acid copolymer resin that contains 9 weight % of acrylic acid and has a melting point of 97° C., and the ‘resin f’ is a sodium salt of an ethylene acrylic acid copolymer resin that contains 9 weight % of acrylic acid, is partially in the form of a sodium salt, and has a melting point of 88° C. As the lubricant, an amide-based lubricant, erucamide was used. As the additive, 2 parts by weight of zinc stearate was used based on 100 parts by weight of the resin. And, as an antioxidant, 1.5 parts by weight of tetrakis[methylene-3-(3,5-di-t-butyl-4′-hydroxyphenyl)propionate]methane was used based on 100 parts by weight of the resin.

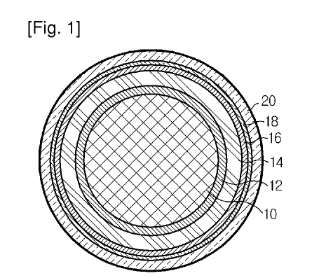

Cable samples were manufactured using the compositions prepared according to Table 1 with a cross-sectional shape of FIG. 1 by means of a single screw extruder.

FIG. 1 is a cross-sectional view of an insulating cable having an outer semiconductive layer formed using a composition according to the present invention. Referring to FIG. 1, the insulating cable includes a center conductor 10, an inner semiconductive layer 12, a water-crosslinked insulating layer 14, an outer semiconductive layer 16, a copper tape 18 and an outermost PVC sheath layer 20. The outer semiconductive layer 16 was formed using the composition prepared according to Table 1.

The cable sample was tested to measure and evaluate characteristics at room temperature, characteristics at heating, peel force, volume resistance and thermal deformation characteristics during water-crosslinking at 80° C. for 16 hours. The evaluation results are shown in the following Table 2.

TABLE 2

| | | Examples | | | | | Comparative examples | | | | |
|---|---|---|---|---|---|---|---|---|---|---|---|
| Classification | | 1 | 2 | 3 | 4 | 5 | 1 | 2 | 3 | 4 | 5 |
| Room | Tensile | 1.43 | 1.49 | 1.61 | 1.45 | 1.03 | 1.42 | 1.72 | 1.35 | 1.56 | 1.05 |
| temperature | strength | | | | | | | | | | |
| | (kgf/mm²) | | | | | | | | | | |
| | Elongation | 196 | 210 | 145 | 180 | 250 | 215 | 85 | 225 | 350 | 55 |
| | (%) | | | | | | | | | | |
| Heating | Residual | 124 | 130 | 122 | 120 | 105 | 122 | 115 | 119 | 120 | 110 |
| | tensile | | | | | | | | | | |
| | strength | | | | | | | | | | |
| | (%) | | | | | | | | | | |
| | Residual | 97 | 110 | 93 | 95 | 102 | 96 | 92 | 91 | 99 | 97 |
| | elongation | | | | | | | | | | |
| | (%) | | | | | | | | | | |

| | | | | | | | | | | |
|---|---|---|---|---|---|---|---|---|---|---|
| Peel force (N/cm) | 15 | 13 | 14 | 15 | 20 | 40 | 25 | 20 | fail | fail |
| Volume resistance | 0.03 | 0.04 | 0.03 | 0.03 | 0.05 | 0.03 | 0.04 | 0.03 | 5000 | 0.01 |
| (Ωm) | | | | | | | | | | |
| Thermal deformation | pass | pass | pass | pass | pass | pass | pass | fail | pass | pass |
| resistance | | | | | | | | | | |

The characteristics at room temperature of the cable sample were measured according to IEC 60502-2, and when a tension test speed is 250 mm/min, a preferable tensile strength is 0.92 kgf/mm² or above and a preferable elongation is 100% or above. It is found through Table 2 that the cable samples of the examples 1 to 5 have good tensile strength and elongation, but the cable samples of the comparative examples 2 and 5 have elongation below standard.

The characteristics at heating of the cable sample were measured according to IEC 60502-2 after the cable sample was left at 136° C. for 168 hours, and a preferable residual tensile strength is 75% or above and a preferable residual elongation is 90% or above. It is found through Table 2 that the cable samples of the examples 1 to 5 and the comparative examples 1 to 5 satisfy the residual tensile strength and residual elongation standards.

The peel force of the cable sample was measured according to IEC 60502-2, and a preferable peel force between an outer semiconductive layer and an insulating layer is 4 N/cm to 45 N/cm. It is found through Table 2 that the cable samples of the examples 1 to 5 and the comparative examples 1 to 3 satisfy the peel force standard. However, the cable samples of the comparative examples 4 and 5 do not satisfy the peel force standard, and a peel force of the cable sample of the comparative example 1 reaches a maximum value of the standard.

The volume resistance of the cable sample was measured according to IEC 60502-2, and a preferable volume resistance of an outer semiconductive layer is 100 Ωm or below. It is found through Table 2 that the cable samples of all the examples and the comparative examples except the comparative example 4 satisfy the volume resistance standard.

In the case that the cable sample is wound on a bobbin and crosslinked, the cable sample should be resistant against thermal deformation. The cable samples of all the examples and the comparative examples except the comparative example 3 satisfy the thermal deformation resistance standard.

As such, the preferred embodiments of the present invention are described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The present invention can be crosslinked at high water-crosslinking temperature without thermal deformation to reduce the crosslinking time, thereby improving process efficiency and performance of products.

1. A semiconductive peelable water-crosslinked resin composition, comprising:
100 parts by weight of a basic resin;
20 to 80 parts by weight of carbon black based on weight of the basic resin; and
0.05 to 5.0 parts by weight of an amide-based lubricant based on weight of the basic resin,
wherein the basic resin is a mixed resin including:
60 to 80 weight % of an ethylene-based copolymer resin that is bonded with an unsaturated organic silane and has a melting point of 80° C. or above;
5 to 20 weight % of an ethylene-acrylic acid copolymer or its alkali metal salt; and
5 to 40 parts by weight of an ethylene propylene copolymer containing 5 to 20 weight % of ethylene, or a propylene rein.

2. The semiconductive peelable water-crosslinked resin composition according to claim 1,
wherein the ethylene-based copolymer resin of the basic resin is any one selected from the group consisting of an ethylene vinyl acetate copolymer resin, an ethylene ethyl acrylate copolymer resin, an ethylene methyl acrylate copolymer resin and an ethylene butyl acrylate copolymer resin.

3. The semiconductive peelable water-crosslinked resin composition according to claim 2,
wherein the ethylene vinyl acetate copolymer resin selected as the ethylene-based copolymer resin contains 9 to 25 weight % of vinyl acetate.

4. The semiconductive peelable water-crosslinked resin composition according to claim 2,
wherein the ethylene ethyl acrylate copolymer resin selected as the ethylene-based copolymer resin contains 9 to 35 weight % of ethyl acrylate.

5. The semiconductive peelable water-crosslinked resin composition according to claim 2,
wherein the ethylene methyl acrylate copolymer resin selected as the ethylene-based copolymer resin contains 9 to 35 weight % of methyl acrylate.

6. The semiconductive peelable water-crosslinked resin composition according to claim 2,
wherein the ethylene butyl acrylate copolymer resin selected as the ethylene-based copolymer resin contains 9 to 35 weight % of butyl acrylate.

7. The semiconductive peelable water-crosslinked resin composition according to claim 2,
wherein the amide-based lubricant contains an amide function (—CON—) in a hydrocarbon main chain, and has a melting point of 50° C. to 120° C.

8. The semiconductive peelable water-crosslinked resin composition according to claim 7,
wherein the amide-based lubricant is any one selected from the group consisting of stearamide, oleamide, erucamide, hydrogenated tallowamide, oleyl palmitamide and stearyl stearamide, or mixtures thereof.

9. An insulating cable, comprising:
a center conductor;
an inner semiconductive layer surrounding the center conductor;
a water-crosslinked insulating layer surrounding the inner semiconductive layer;
an outer semiconductive layer surrounding the water-crosslinked insulating layer;
a copper tape surrounding the outer semiconductive layer; and
a sheath layer surrounding the copper tape,
wherein outer semiconductive layer is formed using the semiconductive peelable water-crosslinked resin composition defined in any one of claims 1 to 8.
